(19) United States
(12) Patent Application Publication
(10) Pub. No.: US 2025/0224311 A1
(43) Pub. Date: Jul. 10, 2025

(54) METHOD OF TESTING VEHICLE CLEAR VISION

(71) Applicant: Ford Motor Company, Dearborn, MI (US)

(72) Inventor: Venkata Rahul Karun Patibandla, Auburn Hills, MI (US)

(73) Assignee: Ford Motor Company, Dearborn, MI (US)

(21) Appl. No.: 18/404,132

(22) Filed: Jan. 4, 2024

(51) Int. Cl. G01M 17/06

(52) U.S. Cl. CPC G01M 17/065

(57) ABSTRACT

A method of testing a vehicle includes positioning the vehicle on a dynamometer, operating a propulsion system to rotate drive wheels at a one or more predetermined speeds while actively adjusting a rotational position of a steering wheel to maintain straight vehicle travel on the dynamometer, measuring angle data of the steering wheel during the active adjusting of the rotational position of the steering wheel, checking the measured angle data to determine if it is outside a predetermined angular range, and outputting, in response to the angle data being outside the predetermined angular range, at least one of a repair ticket and a vehicle fault code.

### FIELD

The present disclosure relates to a method of testing vehicle clear vision.

### BACKGROUND

The statements in this section merely provide background information related to the present disclosure and may not constitute prior art.

Clear vision a term that is used to determine if a steering wheel of the vehicle is centered and pointed in the same direction of the vehicle's travel. Clear vision is the measure (in degrees) of steering wheel rotational position relative to the centered rotational position when the vehicle's travel is straight. Unlike wheel alignment, clear vision is typically not measured or tested for during production of the vehicle. The present disclosure provides a method of testing vehicle clear vision during vehicle production.

### SUMMARY

This section provides a general summary of the disclosure and is not a comprehensive disclosure of its full scope or all of its features.

In one form, the present disclosure provides a method of testing a vehicle that includes a propulsion system, drive wheels, and a steering wheel. The method includes positioning the vehicle on a dynamometer, operating the propulsion system to rotate the drive wheels at a one or more predetermined speeds while actively adjusting a rotational position of the steering wheel to maintain straight vehicle travel on the dynamometer, measuring angle data of the steering wheel during the active adjusting of the rotational position of the steering wheel, checking the measured angle data to determine if it is outside a predetermined angular range, and outputting, in response to the angle data being outside the predetermined angular range, at least one of a repair ticket and a vehicle fault code.

In variations of the method of the above paragraph, which can be implemented individually or in any combination: the active adjusting of the rotational position of the steering wheel is performed by a driver assist system of the vehicle; the active adjusting of the rotational position of the steering wheel is performed by a robot; the one or more predetermined speeds is greater than 40 mph (64.37 kph); the predetermined angular range is −2.5° to 2.5°; the angle data checked is angle data measured during a predetermined operating state of the vehicle, the predetermined operating state is such that a transmission of the vehicle does not shift gears during the predetermined operating state; the predetermined operating state is such that the one or more predetermined speeds is a constant speed; the predetermined operating state is such that the one or more predetermined speeds includes an accelerating speed; the angle data measured is measured by a measurement device removably mounted to exterior of the steering wheel; the angle data measured is measured by a measurement device mounted within the steering wheel, or mounted to the steering column, or mounted within the steering column; the angle data measured is measured by a measurement device that includes an optical sensor configured detect an angular position of the steering wheel; the angle data measured is measured by a measurement device that includes at least one of a gyroscope and an accelerometer; performing a wheel alignment before operating the propulsion system to rotate the drive wheels at the one or more predetermined speeds; and the wheel alignment is performed before positioning the vehicle on the dynamometer.

In another form, the present disclosure provides a method of testing a vehicle that includes a propulsion system, drive wheels, and a steering wheel. The method includes positioning the vehicle on a dynamometer, operating the propulsion system to rotate the drive wheels at a one or more predetermined speeds while actively adjusting a rotational position of the steering wheel to maintain straight vehicle travel on the dynamometer, measuring angle data of the steering wheel during the active adjusting of the rotational position of the steering wheel, checking the measured angle data to determine if it is outside a predetermined angular range, and outputting, in response to the angle data being outside the predetermined angular range, at least one of a repair ticket and a vehicle fault code. The one or more predetermined speeds is greater than 40 mph (64.37 kph).

In variations of the method of the above paragraph, which can be implemented individually or in any combination: the active adjusting of the rotational position of the steering wheel is performed by a driver assist system of the vehicle; the angle data checked is angle data measured during a predetermined operating state of the vehicle, the predetermined operating state is such that a transmission of the vehicle does not shift gears during the predetermined operating state; the predetermined operating state is such that the one or more predetermined speeds is a constant speed; and the predetermined operating state is such that the one or more predetermined speeds includes an accelerating speed.

In yet another form, the present disclosure provides a method of testing a vehicle that includes a propulsion system, drive wheels, and a steering wheel. The method includes positioning the vehicle on a dynamometer, operating the propulsion system to rotate the drive wheels at a one or more predetermined speeds while actively adjusting a rotational position of the steering wheel to maintain straight vehicle travel on the dynamometer, measuring angle data of the steering wheel during the active adjusting of the rotational position of the steering wheel, checking the measured angle data to determine if it is outside a predetermined angular range, and outputting, in response to the angle data being outside the predetermined angular range, at least one of a repair ticket and a vehicle fault code. The one or more predetermined speeds is greater than 40 mph (64.37 kph). The active adjusting of the rotational position of the steering wheel is performed by at least one of a driver assist system of the vehicle and a robot.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a vehicle performance system according to the principles of the present disclosure;

FIG. 2 is a perspective view of the vehicle of FIG. 1 disposed on a dynamometer according to the principles of the present disclosure;

FIG. 3 is a perspective view of a steering wheel of the vehicle of FIG. 1 including one type of steering wheel angle sensor of the performance system according to the principles of the present disclosure;

FIG. 4 is a schematic view of the performance system for testing clear vision of the vehicle according to the principles of the present disclosure;

FIG. 5 is a block diagram showing components of the vehicle performance system of FIG. 1; and

FIG. 6 is a flowchart depicting an algorithm of the vehicle performance system of FIG. 1 for testing a clear vision of the vehicle according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

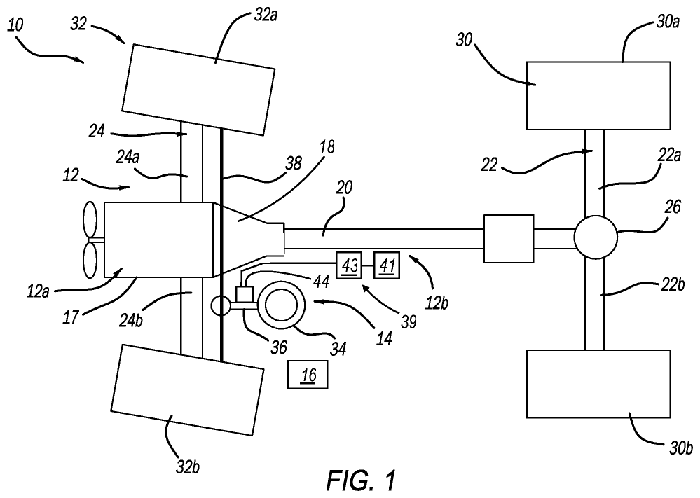

With reference to FIG. 1, a vehicle 10 is provided that includes a propulsion system 12, a steering system 14, and a performance or testing system 16. In the example illustrated, the propulsion system 12 includes a powertrain assembly 12a and drivetrain assembly 12b, which can be conventional assemblies, for example. In the particular configuration shown in FIG. 1, the powertrain assembly 12a includes, inter alia, an engine 17 and a transmission 18. The engine 17 may be an internal combustion engine or an electric motor, for example. The transmission 18 may be an automatic or manual transmission. The drivetrain assembly 12b includes, inter alia, a propeller shaft 20, a primary or drive axle 22, a secondary axle 24, and a rear differential 26. Rotary power (vehicle torque) generated by the powertrain assembly 12a is transmitted to the drivetrain assembly 12b. That is, rotatory power generated by the powertrain assembly 12a is transmitted to the first drive axle 22 via the propeller shaft 20 to drive a set of rear wheels 30. The first drive axle 22 includes a first shaft 22a and a second shaft 22b. The first shaft 22a drives a first wheel 30a of the set of rear wheels 30 and the second shaft 22b drives a second wheel 30b of the set of rear wheels 30. The rear differential 26 drivingly couples the propeller shaft 20 to the first drive axle 22 and can be any suitable type of differential.

In the example provided, the vehicle 10 is a 4-wheel-drive (4WD) or all-wheel-drive (AWD) vehicle such that the secondary axle 24 is also a drive axle and includes a first shaft 24a and a second shaft 24b. The first shaft 24a is connected to a first wheel 32a of a set of front wheels 32 and the second shaft 24b is connected to a second wheel 32b of the set of front wheels 32. In the example provided, the secondary axle 24 includes a front differential (not shown) that receives rotary power from the transmission 18, such as via a power take-off unit (PTU; not shown) or a transfer case (not shown) such that the first shaft 24a drives the first wheel 32a of the set of front wheels 32 and the second shaft 24b drives the second wheel 32b of the set of front wheels 32. In alternative configurations, the vehicle 10 may be a front-wheel-drive (FWD) vehicle or a rear-wheel-drive (RWD) vehicle. In alternative configurations, the front and/or rear wheels may be driven directly by one or more motors.

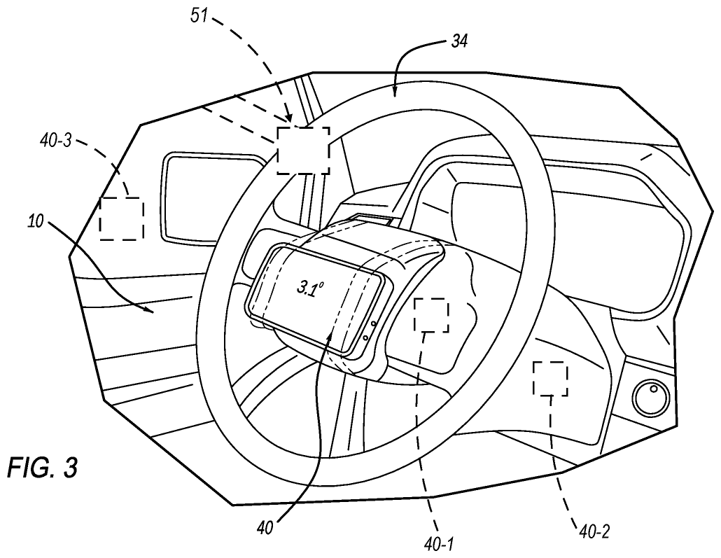

With reference to FIGS. 1 and 3, the steering system 14 includes a steering wheel 34, a rotatable steering column or shaft 36 (FIG. 1), and steering rack 38 (FIG. 1). The steering wheel 34 may be operable (i.e., rotatable) by a driver (not shown) or a driver assist system 39 configured to steer the vehicle 10. The rotatable steering shaft 36 rotates with the steering wheel 34 and may include one or more shaft members drivingly coupled together. The steering shaft 36 includes a first end that is coupled to the steering wheel 34 such that rotation of the steering wheel 34 causes the steering shaft 36 to rotate. A second end of the steering shaft 36 is coupled to the steering rack 38. The steering rack 38 is connected to the first and second wheels 32a, 32b (via respective wheel hubs) such that rotation of the steering wheel 34 steers the first and second wheels 32a, 32b.

In some configurations, the steering system 14 can include gearing between the first end of the steering shaft 36 and the steering wheel 34 and/or between the second end of the steering shaft 36 and the steering rack 38. The gearing can be configured to change (i.e., increase or decrease) the revolutions received by steering rack 38 relative to the revolutions of the steering wheel 34.

In some forms, the steering system 14 may include a linkage assembly (not shown) instead of the steering rack 38. The linkage assembly may be connected to the steering shaft 36 and the first and second wheels 32a, 32b. The linkage assembly may include an input member (not shown) and a tie rod (not shown). A first end of the input member may be drivingly connected to a pitman arm (not shown) and a second end of the input member may be drivingly connected to the first wheel 32a. A first end of the tie rod may be drivingly connected to the first wheel 32a and a second end of the tie rod may be drivingly connected to the second wheel 32b. In this way, when the pitman arm rotates, the input member may change a direction of the first wheel 32a and the tire rod may change a direction of the second wheel 32b.

In some configurations, the steering system 14 may include one or more power assist assemblies. In one form, the power assist assembly may be a hydraulic power assist assembly that is arranged to apply a torque to the steering shaft 36 or hydraulic power to the rack 38 to supplement the driver or the driver assist system 39 input force and change direction of the wheels 32a, 32b. In another form, the power assist assembly may be an electric power assist assembly that includes an electric motor (not shown). The electric power assist assembly may be drivingly connected to the steering shaft 36 or the rack 38 and arranged to supplement the driver or driver assist system 39 input force and change direction of the wheels 32a, 32b.

The driver assist system 39 is a system built into the vehicle 10 and includes sensors 41, a control module 43, and a driver assist motor or actuator 44. The one or more of the sensors 41 are configured to detect a position and velocity of the vehicle 10 relative to the vehicle's surroundings and may be any suitable type of sensor. Some non-limiting types of such as a sensor include cameras, LIDAR, radar, sonar, and GPS, for example. The sensors 41 are in electrical communication (e.g., wired or wireless) with the control module 43. The control module 43 may be a control module dedicated to the driver assist system 39 or may control other systems of the vehicle 10. In one non-limiting example, the control module 43 may be the vehicle's main electronic control unit (ECU). In another configuration, the control module 43 is in communication (e.g., wired or wireless) with the ECU.

The control module 43 is in communication (e.g., wired or wireless) with the driver assist motor or actuator 44. The driver assist motor or actuator 44 is drivingly coupled to the steering system 14 and configured to provide a force thereto to steer the vehicle 10 without input from a driver. In one form, the driver assist motor or actuator 44 is a motor or actuator that applies a force (e.g., torque) to the steering shaft 36. In another form, the driver assist motor or actuator 44 is a motor or actuator that applies a force to the rack 38.

The control module 43 is configured to control operation of the driver assist motor or actuator 44 based on inputs received from the sensors 41. The control module 43 can have various modes or programs for assisting the driver. For example, the control module 43 can be configured to determine whether the vehicle is traveling straight or is turning or otherwise veering to one side or the other based on input from the sensors 41 indicative of movement of the vehicle 10 relative to the vehicle's surroundings. If the control module 43 determines that the vehicle 10 should be traveling in a straight line (e.g., via cues of the vehicle's surroundings detected by the sensors 41 or a specific straight line mode being selected), then the control module 43 can operate the driver assist motor or actuator 44 to adjust the rotational position of the steering wheel 34 so that the vehicle 10 maintains a straight line of travel without input from a driver. In some circumstances, such a mode or program may also be referred to as a lane assist mode and can typically be used to assist the driver in keeping the vehicle in a lane of a road while traveling on a road. In other configurations, the mode may be a specific mode selected to perform a test on the vehicle (e.g., a specific clear view test mode).

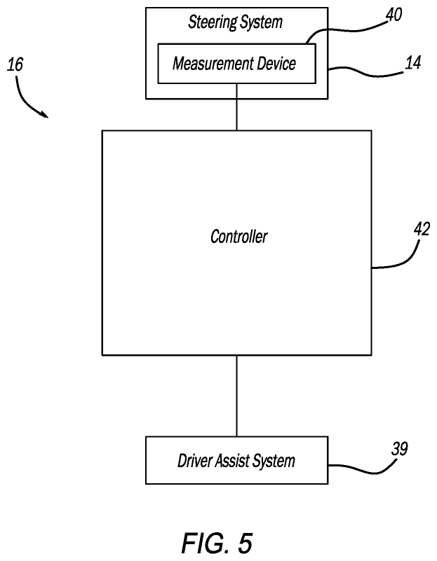

With reference to FIG. 5, the performance system 16 includes one or more measurement devices 40 and a controller 42. Each measurement device 40 is associated with the steering system 14 and is configured to measure angle data of the steering wheel 34 during an operating state of the vehicle 10, which will be described in greater detail below.

In the example illustrated in FIG. 3, the measurement device 40 is removably mounted to an exterior of the steering wheel 34 (FIG. 3). In another form, schematically shown in FIG. 3 by dashed lines, the measurement device 40 may be replaced by a measurement device 40-1 mounted within the steering wheel 34. In yet another form schematically shown in FIG. 3 by dashed lines, the measurement device 40 may be replaced by a measurement device 40-2 mounted to an outside location of the steering column 36 or within the steering column 36. In still another form schematically shown in FIG. 3 by dashed lines, the measurement device 40 may be replaced by a measurement device 40-3 not connected to the steering wheel 34 or the steering column 36 and being located within the passenger compartment of the vehicle 10 or located external to the vehicle 10.

The measurement device 40 may be secured to the steering system 14 using fasteners, clamps, straps (schematically shown in dashed lines in FIG. 3), adhesives, a bracket, or any other suitable attachment structures. The measurement device 40 may optionally include a display configured to visually output the detected angular position.

In one form, one or more of the measurement devices 40, 40-1, 40-2, 40-3 is an optical sensor or other non-contact sensor (e.g., camera, LIDAR, radar, sonar, Hall effect sensor), for example, that is configured to detect an angular position of the steering wheel 34. In another form, one or more of the measurement devices 40, 40-1, 40-2 is a gyroscope, for example, that is configured to measure orientation and angular velocity of the steering wheel 34 and/or the steering column 36. In yet another form, one or more of the measurement devices 40, 40-1, 40-2 is an accelerometer, for example, that is configured to measure the vibration, or acceleration of motion. It should also be understood that the steering system 14 may include a plurality of measurement devices 40, 40-1, 40-2 (e.g., optical sensors, gyroscopes, and/or accelerometers) disposed at various locations of the steering system 14.

The controller 42 is in communication (e.g., wired or wireless) with the measurement devices 40, 40-1, 40-2, 40-3 to receive signals indicative of angular measurements, i.e., measured angular data. The controller 42 may compare the measured angle data to a predetermined angular range. In one form, the predetermined angular range may be equal to or less than +/−2.5 degrees though other ranges may be used. The controller is configured to produce an output in response to the measured angle data being outside the predetermined angular range.

In one form, the controller 42 may output a repair ticket 62 and/or a vehicle fault code 62 based at least in part on the measured angle data from the measurement devices 40, 40-1, 40-2, 40-3 being outside the predetermined range.

The repair ticket 62 and/or the vehicle fault code 62 may optionally include instructions on adjusting the camber angle, toe angle, and/or caster angle at a wheel alignment station 50. The repair ticket 62 and/or the vehicle fault code 62 may optionally include instructions for changing and/or repairing components of the vehicle 10 besides the camber, toe, and caster angles. For example, the repair ticket 62 and/or vehicle fault code 62 may output instructions to replace inspect and/or replace and/or repair components of the steering system 14.

In the example provided, the controller 42 is separate from the control module 43. In one form, the controller 42 is not built into the vehicle 10 and is not integral to the operation of the vehicle 10 and may optionally be located (e.g., temporarily) in the vehicle 10 or external to the vehicle 10. In an alternative configuration, the controller 42 may be the same as or otherwise integrated with the control module 43 or another control module of the vehicle 10.

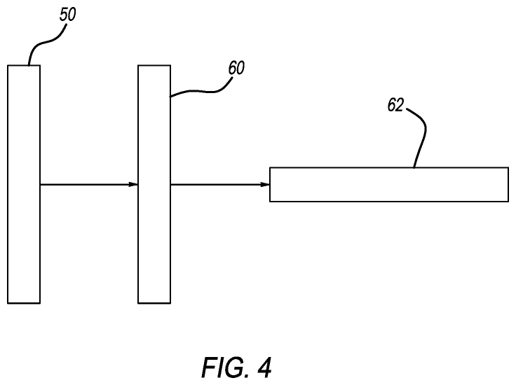

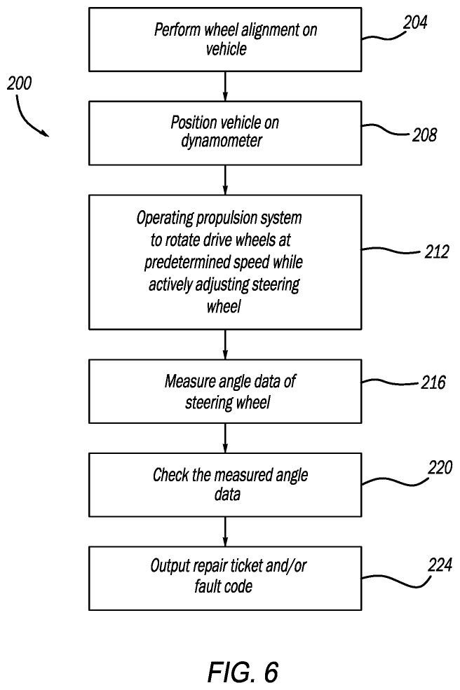

With reference to FIG. 6, a flowchart 200 showing an example implementation of a control algorithm (e.g., method) for testing clear vision of the vehicle 10 is shown. At 204, a wheel alignment is optionally performed on the vehicle 10 at the wheel alignment station 50 (FIG. 4). It should be understood that the wheel alignment performed at the wheel alignment station 50 is performed while the propulsion system 12 is off (i.e., the propulsion system 12 is not rotating the drive wheels 30a, 30b, 32a, 32b at a predetermined speed). The wheel alignment consists of adjusting the angles of the drive wheels 30a, 30b, 32a, 32b (e.g., toe, camber, caster) to reduce tire wear and to provide the vehicle travel is straight. During a wheel alignment, a technician or alignment device checks and/or adjusts the camber, toe, and/or caster of the wheels.

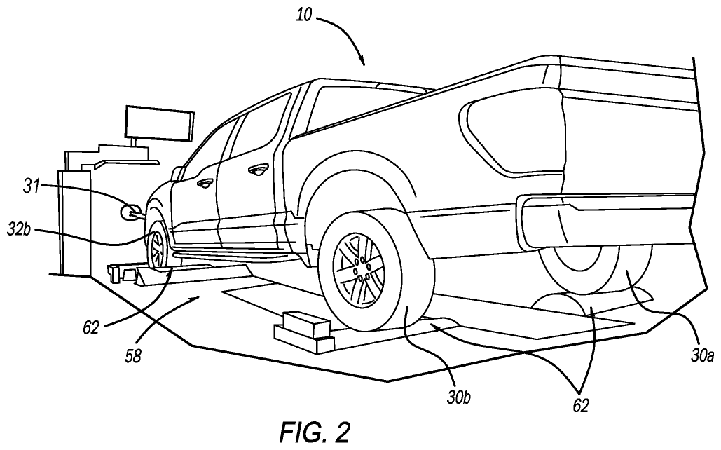

At 208, the vehicle 10 is positioned on a dynamometer 58 (FIG. 2) at a dynamometer station 60 (FIG. 4) to test the drivetrain assembly 12b, to confirm the power and torque provided by the engine 17 and to simulate real world application of the equipment, among other tests. During positioning of the vehicle 10 on the dynamometer 58, the drive wheels 30a, 30b, 32a, 32b are placed on rollers 62 of the dynamometer 58 and the vehicle 10 is anchored via anchors 31 (e.g., straps; one of which is schematically shown) to inhibit the vehicle 10 from moving forward or rearward off of the rollers 62. The anchors 31 are configured to permit the vehicle 10 to move side to side on the rollers 62 a predetermined amount, though they may optionally be configured to inhibit the vehicle 10 from leaving the rollers 62 in the side to side directions. The dynamometer 58 permits the vehicle 10 to be tested at a variety of speeds. In one example, the dynamometer 58 permits the vehicle 10 to be tested at speeds greater than or equal to 40 miles per hour (64.37 kilometers per hour). In some forms, the dynamometer 58 permits the vehicle 10 to be tested at speeds less than 40 miles per hour.

At 212, the powertrain assembly 12a of the vehicle 10 is operated to rotate the drive wheels 30a, 30b, 32a, 32b at one or more predetermined speeds while a rotational position of the steering wheel 34 is actively adjusted to maintain straight vehicle travel on the dynamometer 58.

In one form, the active adjusting of the rotational position of the steering wheel 34 is performed by the driver assist system 39 (FIG. 5). In another form, the active adjusting of the rotational position of the steering wheel 34 is performed by a driver located within the vehicle 10. In still another form, the active adjusting of the rotational positioning of the steering wheel 34 is performed by a robot 51 (shown in dashed lines in FIG. 3) that engages the steering wheel 34 and may be located within the passenger compartment of the vehicle 10 or may extend into the passenger compartment from the exterior of the vehicle 10.

At 216, the controller 42 receives angle data of the steering wheel 34 during the active adjusting of the rotational position of the steering wheel 34. As described above, the angle data of the steering wheel 34 may be measured using measurement devices 40, 40-1, 40-2, 40-3.

At 220, the control algorithm, using the controller 42, checks the measured angle data to determine if it is outside a predetermined angular range. In one form, the predetermined angular range may be equal to or less than +/−2.5 degrees, though other ranges may be used.

The angle data checked is angle data measured during a predetermined operating state of the vehicle 10. In some forms, the predetermined operating state can be a state in which driveline and steering disturbances are expected to be minimal. The predetermined operating state may include any one of the following conditions or any combination thereof: the transmission 18 of the vehicle does not shift gears during the predetermined operating state; the predetermined speed is a constant speed; the transmission 18 is in a highest gear. The predetermined operating state may include any one of the following conditions or any combination thereof: the transmission 18 of the vehicle does not shift gears during the predetermined operating state; the predetermined speed includes an accelerating or decelerating speed; the transmission 18 is in a highest gear.

At 224, the control algorithm, using the controller 42, outputs a repair ticket 62 and/or a vehicle fault code 62 in response to the checked angle data being outside the predetermined angular range. The repair ticket 62 and/or the vehicle fault code 62 may include instructions on adjusting the camber angle, toe angle, and/or caster angle at the wheel alignment station 50, for example and/or may include instructions for changing and/or repairing components of the vehicle 10 besides the camber, toe, and caster angles. For example, the repair ticket 62 and/or vehicle fault code 62 may output instructions to replace inspect and/or replace and/or repair components of the steering system 14. If the measured angle data of the steering wheel 34 is within the predetermined range, the vehicle 10 is indicated as having passed the clear view test and is moved onto the next step in the vehicle testing process.

The method of the present disclosure permits the measuring of the clear vision of a vehicle and, if needed, adjustment of the clear vision before the vehicle leaves the manufacturing facility. This process may be done prior to the vehicle being shipped to the customer and may optionally be performed on every vehicle without driving the vehicle on the road. Additionally, performing the above discussed method on the dynamometer 58 permits the measuring of the clear vision at relatively high vehicle speeds (e.g., speeds greater than 40 miles per hour), which magnifies small inconsistencies in components, or alignments of components, of the steering system 14 and wheels 32, which produces more accurate results relating to testing the clear vision of the vehicle 10. It should be understood that the method and system of the present disclosure may also be used on vehicles after they have been shipped to the customer (i.e., at a dealership or repair facility).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of testing a vehicle that includes a propulsion system, drive wheels, and a steering wheel, the method comprising:
positioning the vehicle on a dynamometer;
operating the propulsion system to rotate the drive wheels at a one or more predetermined speeds while actively adjusting a rotational position of the steering wheel to maintain straight vehicle travel on the dynamometer;
measuring angle data of the steering wheel during the active adjusting of the rotational position of the steering wheel;
checking the measured angle data to determine if it is outside a predetermined angular range; and
outputting, in response to the angle data being outside the predetermined angular range, at least one of a repair ticket and a vehicle fault code.

2. The method according to claim 1, wherein the active adjusting of the rotational position of the steering wheel is performed by a driver assist system of the vehicle.

3. The method according to claim 1, wherein the active adjusting of the rotational position of the steering wheel is performed by a robot.

4. The method according to claim 1, wherein the one or more predetermined speeds is greater than 40 mph (64.37 kph).

5. The method according to claim 1, wherein the predetermined angular range is −2.5° to 2.5°.

6. The method according to claim 1, wherein the angle data checked is angle data measured during a predetermined operating state of the vehicle, wherein the predetermined operating state is such that a transmission of the vehicle does not shift gears during the predetermined operating state.

7. The method according to claim 6, wherein the predetermined operating state is such that the one or more predetermined speeds is a constant speed.

8. The method according to claim 6, wherein the predetermined operating state is such that the one or more predetermined speeds includes an accelerating speed.

9. The method according to claim 1, wherein the angle data measured is measured by a measurement device removably mounted to exterior of the steering wheel.

10. The method according to claim 1, wherein the angle data measured is measured by a measurement device mounted within the steering wheel, or mounted to a steering column, or mounted within the steering column.

11. The method according to claim 1, wherein the angle data measured is measured by a measurement device that includes an optical sensor configured detect an angular position of the steering wheel.

12. The method according to claim 1, wherein the angle data measured is measured by a measurement device that includes at least one of a gyroscope and an accelerometer.

13. The method according to claim 1, further comprising performing a wheel alignment before operating the propulsion system to rotate the drive wheels at the one or more predetermined speeds.

14. The method according to claim 13, wherein the wheel alignment is performed before positioning the vehicle on the dynamometer.

15. A method of testing a vehicle that includes a propulsion system, drive wheels, and a steering wheel, the method comprising:
positioning the vehicle on a dynamometer;
operating the propulsion system to rotate the drive wheels at a one or more predetermined speeds while actively adjusting a rotational position of the steering wheel to maintain straight vehicle travel on the dynamometer, wherein the one or more predetermined speeds is greater than 40 mph (64.37 kph);
measuring angle data of the steering wheel during the active adjusting of the rotational position of the steering wheel;
checking the measured angle data to determine if it is outside a predetermined angular range; and
outputting, in response to the angle data being outside the predetermined angular range, at least one of a repair ticket and a vehicle fault code.

16. The method according to claim 15, wherein the active adjusting of the rotational position of the steering wheel is performed by a driver assist system of the vehicle.

17. The method according to claim 15, wherein the angle data checked is angle data measured during a predetermined operating state of the vehicle, wherein the predetermined operating state is such that a transmission of the vehicle does not shift gears during the predetermined operating state.

18. The method according to claim 17, wherein the predetermined operating state is such that the one or more predetermined speeds is a constant speed.

19. The method according to claim 17, wherein the predetermined operating state is such that the one or more predetermined speeds includes an accelerating speed.

20. A method of testing a vehicle that includes a propulsion system, drive wheels, and a steering wheel, the method comprising:
positioning the vehicle on a dynamometer;
operating the propulsion system to rotate the drive wheels at a one or more predetermined speeds while actively adjusting a rotational position of the steering wheel to maintain straight vehicle travel on the dynamometer, wherein the one or more predetermined speeds is greater than 40 mph (64.37 kph), wherein the active adjusting of the rotational position of the steering wheel is performed by at least one of a driver assist system of the vehicle and a robot;
measuring angle data of the steering wheel during the active adjusting of the rotational position of the steering wheel;
checking the measured angle data to determine if it is outside a predetermined angular range; and
outputting, in response to the angle data being outside the predetermined angular range, at least one of a repair ticket and a vehicle fault code.
